(19) United States
(12) Patent Application Publication
(10) Pub. No.: US 2002/0158438 A1
(43) Pub. Date: Oct. 31, 2002

(54) Running board protective cover

(76) Inventor: Charles Jacobs JR., Mentone, CA (US)

Correspondence Address: Richard W. Goldstein, 2071 Clove Road, Staten Island, NY, 10304, US

(21) Appl. No.: 09/844,606

(22) Filed: Apr. 27, 2001

(51) Int. Cl. B60R 3/00

(52) U.S. Cl. 280/163

(57) ABSTRACT

A running board protective cover including a cover member dimensioned for being positioned atop an existing running board of a vehicle. The cover member has an elongated generally rectangular configuration. The cover member has an upper surface, a lower surface, a long inner edge, a long outer edge, and opposed short end edges.

### BACKGROUND OF THE INVENTION

The present invention relates to a running board protective cover and more particularly pertains to preventing a running board from becoming damaged while also facilitating ingress and egress from a vehicle.

The use of vehicle accessory devices is known in the prior art. More specifically, vehicle accessory devices heretofore devised and utilized for the purpose of protecting vehicles are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,203,611 to Makela discloses means for attaching running boards to a light truck, to increase the ease of entry and exit. U.S. Pat. No. 3,684,311 to Pierce discloses a mudguard attachment for a vehicle to protect the sides of the vehicle from splattered mud and gravel damage. U.S. Pat. No. 5,286,049 to Khan discloses a running board for a vehicle.

While these devices fulfill their respective, particular objective and requirements, the aforementioned patents do not describe a running board protective cover for preventing a running board from becoming damaged while also facilitating ingress and egress from a vehicle.

In this respect, the running board protective cover according to the present invention substantially departs from the conventional concepts and designs of the prior art, and in doing so provides an apparatus primarily developed for the purpose of preventing a running board from becoming damaged while also facilitating ingress and egress from a vehicle.

Therefore, it can be appreciated that there exists a continuing need for a new and improved running board protective cover which can be used for preventing a running board from becoming damaged while also facilitating ingress and egress from a vehicle. In this regard, the present invention substantially fulfills this need.

### SUMMARY OF THE INVENTION

In the view of the foregoing disadvantages inherent in the known types of vehicle accessory devices now present in the prior art, the present invention provides an improved running board protective cover. As such, the general purpose of the present invention, which will be described subsequently in greater detail, is to provide a new and improved running board protective cover which has all the advantages of the prior art and none of the disadvantages.

To attain this, the present invention essentially comprises a cover member dimensioned for being positioned atop an existing running board of a vehicle for entirely covering the existing running board. The cover member has an elongated generally rectangular configuration. The cover member has an upper surface, a lower surface, a long inner edge, a long outer edge, and opposed short end edges. The upper surface has a plurality of linear groves formed therein extending between the opposed short end edges. The long inner edge has an upwardly extending lip integrally formed therewith. The long outer edge has a downwardly extending lip integrally formed therewith. The downwardly extending lip includes side lips extending downwardly from the opposed short end edges.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved running board protective cover which has all the advantages of the prior art vehicle accessory devices and none of the disadvantages.

It is another object of the present invention to provide a new and improved running board protective cover which may be easily and efficiently manufactured and marketed.

It is a further object of the present invention to provide a new and improved running board protective cover which is of durable and reliable construction.

An even further object of the present invention is to provide a new and improved running board protective cover which is susceptible of a low cost of manufacture with regard to both materials and labor, and which accordingly is then susceptible of low prices of sale to the consuming public, thereby making such a running board protective cover economically available to the buying public.

Even still another object of the present invention is to provide a new and improved running board protective cover for preventing a running board from becoming damaged while also facilitating ingress and egress from a vehicle.

Lastly, it is an object of the present invention to provide a new and improved running board protective cover including a cover member dimensioned for being positioned atop an existing running board of a vehicle. The cover member has an elongated generally rectangular configuration. The cover member has an upper surface, a lower surface, a long inner edge, a long outer edge, and opposed short end edges.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the running board protective cover constructed in accordance with the principles of the present invention.

FIG. 2 is a perspective view of the present invention illustrated separated from a running board.

The same reference numerals refer to the same parts through the various FIGS.

### DESCRIPTION OF THE PREFERRED EMBODIMENT

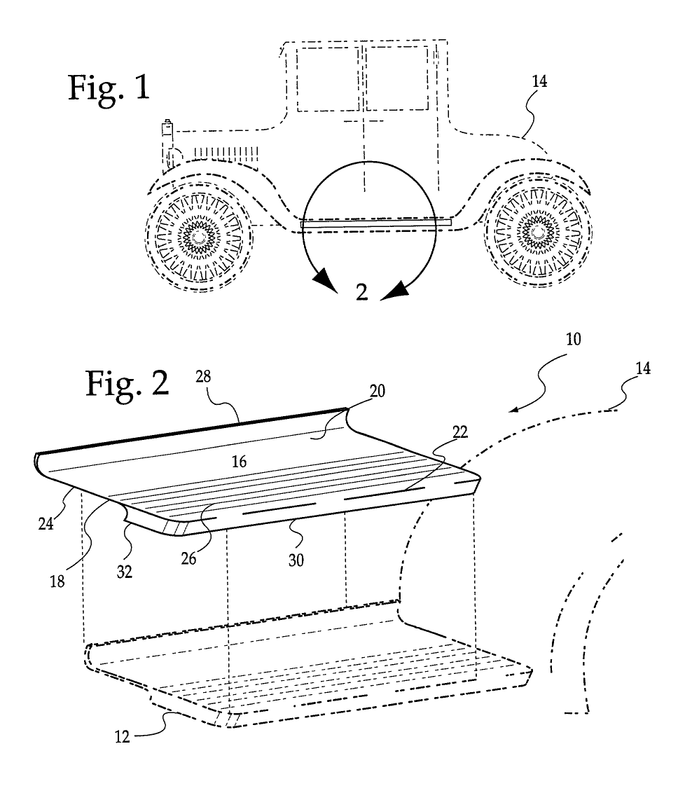

With reference now to the drawings, and in particular, to FIGS. 1 through two thereof, the preferred embodiment of the new and improved running board protective cover embodying the principles and concepts of the present invention and generally designated by the reference number 10 will be described.

Specifically, it will be noted in the various Figures that the device relates to a running board protective cover for preventing a running board from becoming damaged while also facilitating ingress and egress from a vehicle.

The present invention is essentially comprised of a cover member 10. The cover member 10 is dimensioned for being positioned atop an existing running board 12 of a vehicle 14 for entirely covering the existing running board 12. Note FIG. 1. The cover member 10 has an elongated generally rectangular configuration. The cover member 10 has an upper surface 16, a lower surface 18, a long inner edge 20, a long outer edge 22, and opposed short end edges 24. The upper surface 16 has a plurality of linear groves 26 formed therein extending between the opposed short end edges 24. The long inner edge 20 has an upwardly extending lip 28 integrally formed therewith. The long outer edge 22 has a downwardly extending lip 30 integrally formed therewith. The downwardly extending lip 30 includes side lips 32 extending downwardly from the opposed short end edges 24. The shape of the cover member 10 corresponds with the shape of the running board 12. Note FIG. 2.

The present invention is designed to protect the running board 12 from the onset of rust, scratches, and abrasions. The grooves 26 on the upper surface 16 prevent a person stepping on the present invention from slipping when entering and exiting the vehicle 14. Additionally, the present invention could be used to cover existing damage on the running board 12. Furthermore, the present invention could help deaden road noise and vibrations associated with the running board 12.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

1. A running board protective cover for preventing a running board from becoming damaged while also facilitating ingress and egress from a vehicle, the protective cover comprising, in combination:
a cover member dimensioned for being positioned atop an existing running board of a vehicle for entirely covering the existing running board, the cover member having an elongated generally rectangular configuration, the cover member having an upper surface, a lower surface, a long inner edge, a long outer its edge, and opposed short end edges, the upper surface having a plurality of linear groves formed therein extending between the opposed short end edges, the long inner edge having an upwardly extending lip integrally formed therewith, the long outer edge having a downwardly extending lip integrally formed therewith, the downwardly extending lip including side lips extending downwardly from the opposed short end edges.

2. A running board protective cover for preventing a running board from becoming damaged while also facilitating ingress and egress from a vehicle, the protective cover comprising, in combination:
a cover member dimensioned for being positioned atop an existing running board of a vehicle, the cover member having an elongated generally rectangular configuration, the cover member having an upper surface, a lower surface, a long inner edge, a long outer edge, and opposed short end edges.

3. The running board protective cover as set forth in claim two, wherein the cover member entirely covering the existing running board.

4. The running board protective cover as set forth in claim two, wherein the upper surface of the cover member has a plurality of linear groves formed therein extending between the opposed short end edges.

5. The running board protective cover as set forth in claim two, wherein the long inner edge has an upwardly extending lip integrally formed therewith.

6. The running board protective cover as set forth in claim two, wherein the long outer edge has a downwardly extending lip integrally formed therewith.

7. The running board protective cover as set forth in claim six, wherein the downwardly extending lip includes side lips extending downwardly from the opposed short end edges.
